(19) United States
(12) Patent Application Publication
(10) Pub. No.: US 2023/0352757 A1
(43) Pub. Date: Nov. 2, 2023

(54) METHOD FOR RECYCLING LITHIUM-ION SECONDARY BATTERY

(71) Applicant: NGK INSULATORS, LTD., Nagoya-City (JP)

(72) Inventors: Yuki TANAKA, Nagoya-City (JP); Nobuyuki KOBAYASHI, Nagoya-City (JP)

(73) Assignee: NGK INSULATORS, LTD., Nagoya-City (JP)

(21) Appl. No.: 18/350,080

(22) Filed: Jul. 11, 2023

Related U.S. Application Data
(63) Continuation of application No. PCT/JP2021/048043, filed on Dec. 23, 2021.

(30) Foreign Application Priority Data
Jan. 27, 2021 (JP) 2021-011522

(51) Int. Cl. H01M 10/54; H01M 10/0525; H01M 10/42; H01M 4/1391; H01M 4/04; H01M 50/434; H01M 4/525; H01M 4/485

(52) U.S. Cl. CPC H01M 10/54; H01M 10/0525; H01M 10/4242; H01M 4/1391; H01M 4/0471; H01M 50/434; H01M 4/525; H01M 4/485

(57) ABSTRACT

Provided is a method for recycling a lithium-ion secondary battery, which includes: providing a used lithium-ion secondary battery that includes: a battery element including a ceramic positive electrode layer, a ceramic separator, and a ceramic negative electrode layer; an electrolytic solution; and a battery container accommodating the battery element and the electrolytic solution, taking out the battery element from the lithium-ion secondary battery, replacing the electrolytic solution in the lithium-ion secondary battery with a fresh electrolytic solution, subjecting the battery element to an electrode restoration treatment including cleaning and/or heat treatment, and putting the battery element subjected to the electrode restoration treatment back into the battery container to assemble a lithium-ion secondary battery.

### CROSS-REFERENCE TO RELATED APPLICATIONS

This application is a continuation application of PCT/JP2021/048043 filed Dec. 23, 2021, which claims priority to Japanese Patent Application No. 2021-011522 filed Jan. 27, 2021, the entire contents all of which are incorporated herein by reference.

### BACKGROUND OF THE INVENTION

### 1. Field of the Invention

The present invention relates to a method for recycling a lithium-ion secondary battery.

### 2. Description of the Related Art

Various methods have been proposed for recycling lithium-ion secondary batteries or their components. For example, Patent Literature 1 (JP2014-127417A) discloses a method for recycling a negative electrode active material layer and has proposed that a negative electrode having a negative electrode active material layer containing a non-aqueous binder and a current collector is immersed in an aqueous solution, the separated negative electrode active material layer is recovered, and the recovered negative electrode active material layer is attached again to the current collector. Patent Literature 2 (JP2019-145315A) discloses a method for recycling a lithium-ion secondary battery, comprising injecting dry air into a used lithium-ion secondary battery containing a non-aqueous electrolyte. Patent Literature 3 (JP5077788B) discloses a method for recovering cobalt and lithium from a battery material and has proposed that the electrode material is dissolved in sulfuric acid to form a solution in which cobalt ions and lithium ions are dissolved, and this solution is separated from the insoluble matter. Patent Literature 4 (JP5664043B) discloses a method for recycling a waste lithium ion battery electrolytic solution, comprising recovering an electrolytic solution from a waste lithium ion battery and using the electrolytic solution as fuel. Patent Literature 5 (JP2014-82120A) discloses a system for determining whether a non-aqueous electrolyte secondary battery is suitable for reuse, comprising a first acquisition unit that acquires a first measurement value obtained by measuring the amount of lithium fluoride coating formed on the positive electrode, a first storage unit that stores a previously obtained first range of the lithium fluoride coating formed on the positive electrode, and a first determination unit that determines whether the target battery is suitable for recycling based on the first measurement value and the first range.

Meanwhile, in many existing lithium-ion secondary batteries, a powder-dispersed positive electrode (so-called coated electrode) produced by applying and drying a positive electrode mixture containing a positive electrode active material, a conductive additive, a binder, or the like is adopted.

In general, a powder-dispersed positive electrode contains a relatively large amount (e.g., about 10 wt %) of components (such as binders and conductive additives) that do not contribute to the capacity and thus has a low packing density of the lithium complex oxide as the positive electrode active material. Accordingly, the powder-dispersed positive electrode should be greatly improved from the viewpoint of the capacity and charge/discharge efficiency. Some attempts have been made to improve the capacity and charge/discharge efficiency by positive electrodes or layers of positive electrode active material composed of lithium complex oxide sintered plate. In this case, since the positive electrode or the positive electrode active material layer does not contain binders or conductive additives (e.g., conductive carbons), it is expected to have high capacity and good charge/discharge efficiency due to high packing density of the lithium complex oxide. For example, Patent Literature 6 (JP6374634B) discloses a lithium complex oxide sintered plate such as lithium cobaltate LiCoO₂ (which will be hereinafter referred to as LCO) that is used for a positive electrode of a lithium-ion secondary battery. This lithium complex oxide sintered plate has a structure in which a plurality of primary grains having a layered rock salt structure are bonded and a porosity of 3 to 40%, a mean pore diameter of 15 μm or less, an open pore rate of 70% or more, a thickness of 15 to 200 μm, and a primary grain size that is the average grain size of the plurality of primary grains of 20 μm or less. In addition, the lithium complex oxide sintered plate has an average of the angles defined by the (003) planes of the plurality of primary grains and the plate face of the lithium complex oxide sintered plate, that is, a mean tilt angle of more than 0° to 30° or less.

Meanwhile, use of a titanium-containing sintered plate as a negative electrode has been also proposed. For example, Patent Literature 7 (JP6392493B) discloses a sintered plate of lithium titanate Li₄Ti₅O₁₂ (which will be hereinafter referred to as LTO) used for a negative electrode of a lithium-ion secondary battery. The LTO sintered plate has a structure in which a plurality of primary grains are bonded and a thickness of 10 to 290 μm, a primary grain size that is the average grain size of the plurality of primary grains of 1.2 μm or less, a porosity of 21 to 45%, and an open pore rate of 60% or more.

There is also proposed a lithium-ion secondary battery with both high discharge capacity and excellent charge/discharge cycle by employing a configuration in which a positive electrode layer, a separator, and a negative electrode layer form one integrated sintered plate as a whole. For example, Patent Literature 8 (WO2019/221140A1) discloses a lithium-ion secondary battery comprising a positive electrode layer composed of a sintered body of lithium complex oxide (e.g., lithium cobaltate), a negative electrode layer composed of a titanium-containing sintered body (e.g., lithium titanate), a ceramic separator, and an electrolyte with which the ceramic separator is impregnated. In this battery, the positive electrode layer, the ceramic separator, and the negative electrode layer form one integrated sintered plate as a whole, whereby the positive electrode layer, the ceramic separator, and the negative electrode layer are bonded together.

### CITATION LIST

### Patent Literature

Patent Literature 1: JP2014-127417A

Patent Literature 2: JP2019-145315A

Patent Literature 3: JP5077788B

Patent Literature 4: JP5664043B

Patent Literature 5: JP2014-82120A

Patent Literature 6: JP6374634B

Patent Literature 7: JP6392493B

Patent Literature 8: WO2019/221140A1

### SUMMARY OF THE INVENTION

Recycling of the lithium-ion secondary batteries or their components as described above is roughly divided into re-cycling (resource recovery) and re-use (reuse). Re-cycling of batteries involves recovery of materials such as electrodes as active materials or alloys, but the cost is high due to complicated processes. Meanwhile, regarding re-use of batteries, batteries are reused by evaluating the performance of the batteries and sorting them into different applications according to the degree of deterioration. For example, if the degree of deterioration is small, it can be reused for electric vehicles (EV) and forklifts, and if the degree of deterioration is large, it can be reused for backup power supply applications.

As described above, the process of re-cycling lithium ion secondary batteries is complicated and the cost is high, while the applications of re-use are limited. For this reason, the current situation is that the recycling of lithium ion secondary batteries or their components has hardly progressed. In particular, since conventional lithium-ion secondary batteries that contain an electrode containing an organic binder or a conductive additive have many deterioration factors, it has been difficult to take out the used electrode and recycle it as an electrode as it is.

The inventors have now found that by employing a used sintered body-type lithium-ion secondary battery comprising a battery element including a ceramic positive electrode layer, a ceramic separator, and a ceramic negative electrode layer and replacing the electrolytic solution and cleaning and/or heat-treating the battery element, it is possible to reassemble a lithium-ion secondary battery whose performance has been sufficiently restored with simple procedure at low cost.

Accordingly, an object of the present invention is to provide a method for recycling a lithium-ion secondary battery, which employs a used lithium-ion secondary battery and makes it possible to reassemble a lithium-ion secondary battery whose performance is sufficiently restored with simple procedure at low cost.

According to an aspect of the present invention, there is provided a method for recycling a lithium-ion secondary battery, comprising:
providing a used lithium-ion secondary battery that includes: a battery element including a ceramic positive electrode layer, a ceramic separator, and a ceramic negative electrode layer; an electrolytic solution; and a battery container accommodating the battery element and the electrolytic solution;
taking out the battery element from the lithium-ion secondary battery;
replacing the electrolytic solution in the lithium-ion secondary battery with a fresh electrolytic solution;
subjecting the battery element to an electrode restoration treatment including cleaning and/or heat treatment; and
putting the battery element subjected to the electrode restoration treatment back into the battery container to assemble a lithium-ion secondary battery.

### BRIEF DESCRIPTION OF THE DRAWINGS

FIG. 1 is a schematic sectional view of an example of the lithium-ion secondary battery to be used in the method of the present invention.

FIG. 2 is a SEM image showing an example of a cross section perpendicular to the layer face of an oriented positive electrode layer.

FIG. 3 is an EBSD image in the cross section of the oriented positive electrode layer shown in FIG. 2.

FIG. 4 is an area-based histogram showing the distribution of orientation angles of primary grains in the EBSD image shown in FIG. 3.

FIG. 5 is a schematic sectional view showing a layer structure of the green sheet laminate produced in each of Examples 6 to 9.

FIG. 6 is a cross-sectional perspective view schematically showing the cutting positions of the green sheet laminate produced in each of Examples 6 to 9.

### DETAILED DESCRIPTION OF THE INVENTION

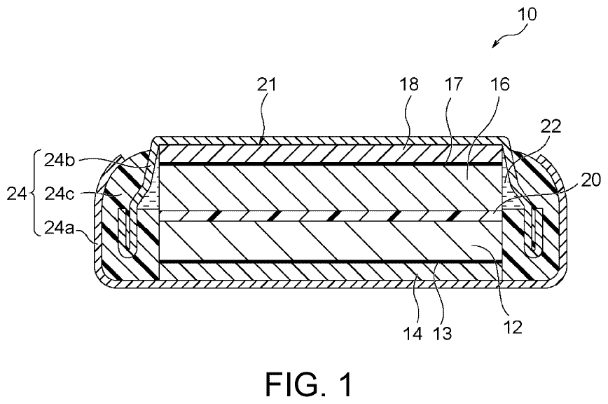

Method for recycling lithium-ion secondary battery The used lithium-ion secondary battery to be used in the method of the present invention is a sintered body-type battery (semi-solid battery) comprising a battery element including a ceramic positive electrode layer, a ceramic separator, and a ceramic negative electrode layer together with an electrolytic solution. FIG. 1 schematically shows an example of such a sintered body-type lithium-ion secondary battery. The lithium-ion secondary battery 10 shown in FIG. 1 is a coin-shaped battery, but the present invention is not limited to this example, and batteries in other forms such as button batteries, cylindrical batteries, prismatic batteries, pack batteries, car batteries, and sheet batteries may be used.

That is, in the method for recycling a lithium-ion secondary battery according to the present invention, the used lithium-ion secondary battery 10 comprising a battery element 21 including a ceramic positive electrode layer 12, a ceramic separator 20, and a ceramic negative electrode layer 16, an electrolytic solution 22, and a battery container 24 accommodating the battery element 21 and the electrolytic solution 22 is first prepared. Then, the battery element 21 is taken out from the lithium-ion secondary battery 10, and then the electrolytic solution 22 in the lithium-ion secondary battery 10 is replaced with a fresh electrolytic solution 22. Then, the battery element 21 is subjected to electrode restoration treatment including cleaning and/or heat treatment. Finally, the battery element 21 subjected to the electrode restoration treatment is put back into the battery container 24, to assemble the lithium-ion secondary battery 10. In this way, by employing the used sintered body-type lithium-ion secondary battery 10 comprising the battery element 21 including the ceramic positive electrode layer 12, the ceramic separator 20, and the ceramic negative electrode layer 16 and replacing the electrolytic solution 22 and cleaning and/or heat-treating the battery element 21, it is possible to reassemble the lithium-ion secondary battery 10 whose performance is sufficiently restored with simple procedure at low cost.

As has been mentioned above, re-cycling of lithium-ion secondary batteries is complicated and expensive, while re-use has limited applications. For this reason, the current situation is that the recycling of lithium ion secondary batteries or their components has hardly progressed. In particular, since conventional lithium-ion secondary batteries that contain an electrode containing an organic binder or a conductive additive have many deterioration factors, it has been difficult to take out the used electrode and recycle it as an electrode as it is. This problem is advantageously overcome by the present invention. This is explained as follows.

First, various factors are conceivable as general deterioration factors of conventional lithium-ion secondary batteries. First, at the time of manufacturing the battery or at the initial stage of use, a carbonic acid layer or a fluorinated layer is generated, and a gas is generated on the electrode surface due to the reaction between the water contained in the electrolyte and the electrolyte anion PF₅₋, the reaction between PF₅ or HF generated due to the aforementioned reaction and a solvent, the reaction between the electrolyte and an active material, or the side reaction thereof. Thereafter, the use of the battery causes deterioration and reduction of the active material itself used in the active material layer of the electrode. Due to repeated charging and discharging, cracking of grains due to changes in swelling and contraction of grains, structural deterioration and destruction due to phase change and strain, dissolution of the positive electrode active material, deposition of the dissolved material on the negative electrode, a short circuit between the positive electrode and the negative electrode due to this, depletion of lithium ions, formation of Li dendrites at the negative electrode due to low temperature operation/high current operation, a decrease in lithium ions and a short circuit between the positive electrode and the negative electrode due to this, and deterioration of the interface are induced. In addition, corrosion of the surface of the current collector, separation of the active material from the current collector, deterioration of the conductivity of the electrode, change and unevenness of the conductive network in the active material layer, deterioration of the binder, and clogging of the separator occur, and the internal resistance of the cell is increased by these changes. In addition, depending on the usage conditions, various factors can be mentioned as causes of capacity deterioration such as a decrease in reaction amount of the active material due to overcharge or overdischarge, deterioration due to oxidation and reduction reactions of the electrolyte, deterioration of the reaction interface layer, and deterioration due to expansion and contraction of the electrode during charging and discharging.

In contrast, the used lithium-ion secondary battery to be used in the present invention is a sintered body-type battery (hereinafter referred to as “semi-solid battery”) comprising the battery element 21 including the ceramic positive electrode layer 12, the ceramic separator 20, and the ceramic negative electrode layer 16, together with the electrolytic solution 22, and has fewer deterioration factors than general lithium-ion secondary batteries, the battery element 21 is robust because they are composed of ceramics, and the battery can be reassembled by replacing the electrolytic solution 22 any number of times. Advantageously, the main deterioration modes in such a semi-solid battery are only “reaction between an electrolyte and an active material” and “dissolution of the positive electrode active material” among the above-mentioned extremely diverse deterioration factors. That is, since each layer of the battery element 21 in the semi-solid battery is composed of ceramic (that is, a sintered body), it is free from components that cause deterioration, such as an organic binder (the organic binder disappears by sintering). As a result, the ceramic electrode free from binders or the like is less deteriorated (there is no deterioration due to the binder). In addition, since the positive electrode/separator/negative electrode laminated structure is made of ceramics, it can be taken out in its original form even after use and can be easily handled. Moreover, since this structure is made of ceramics alone (even if the metal foil is attached, it can be detached or separated), it is possible to perform heat treatment such as degreasing and firing as well as cleaning. Although deterioration due to oxidative decomposition of the electrolytic solution 22 occurs, the performance of the battery can be restored to some extent simply by replacing the electrolytic solution 22 because the deterioration of the ceramic electrode itself is small. Accordingly, the method of the present invention makes it possible to reassemble a lithium-ion secondary battery whose performance is sufficiently restored using a used lithium-ion secondary battery with simple procedure at low cost.

(1) Preparation of Used Lithium-Ion Secondary Battery

The used lithium-ion secondary battery 10 is prepared. The lithium-ion secondary battery 10 is a sintered body-type battery (semi-solid battery) comprising the battery element 21 including the ceramic positive electrode layer 12, the ceramic separator 20, and the ceramic negative electrode layer 16, the electrolytic solution 22, and a battery container accommodating the battery element 21 and the electrolytic solution 22. Such sintered body-type batteries are known as disclosed in Patent Literatures 7 and 8, and the preferable configurations thereof will be described later. In particular, it is preferable that the ceramic positive electrode layer 12, the ceramic separator 20, and the ceramic negative electrode layer 16 form one integrated sintered body as a whole, since there is no need of separately handling the ceramic positive electrode layer 12, the ceramic negative electrode layer 16, and the separator 20 as an integrated sintered body unit, for improving the working efficiency. The battery element may further comprise a positive electrode current collector 14 and/or a negative electrode current collector 18.

(2) Taking Out Battery Element

The battery element 21 are taken out from the lithium-ion secondary battery 10 (specifically, the battery container 24). The battery element 21 may be appropriately taken out according to the configuration of the battery container 24 by detaching part of the battery container 24 (e.g., a negative electrode can 24b), opening the inside of the battery, and taking out the battery element 21. In particular, in the case where the ceramic positive electrode layer 12, the ceramic separator 20, and the ceramic negative electrode layer 16 form one integrated sintered body as a whole, the integrated sintered body can be taken out from the battery container 24 as a whole, which is particularly advantageous in terms of ease of work.

(3) Replacement of Electrolytic Solution

The electrolytic solution 22 inside the lithium-ion secondary battery 10 (specifically, inside the battery container 24) is replaced with a fresh electrolytic solution 22. The electrolytic solution 22 is preferably replaced after taking out the battery element 21, but there is no limitation to this. For example, in the case of replacing the battery container 24, the fresh electrolytic solution 22 may be put into another replaced battery container 24. The fresh electrolytic solution 22 may have the same composition as the electrolytic solution 22 initially used in the lithium-ion secondary battery 10, or the electrolytic solution 22 having a different composition from the initially used electrolytic solution 22 may be used, as long as an acceptable performance can be exerted. For example, the electrolytic solution 22 that provides better performance as compared to the initially used electrolytic solution 22 may be used. Details of preferable examples of the electrolytic solution 22 will be described later.

(4) Electrode Restoration Treatment

The battery element 21 is subjected to electrode restoration treatment including cleaning and/or heat treatment. The method of the electrode restoration treatment is not particularly limited as long as it includes cleaning and/or heat treatment that can improve the deteriorated electrode performance. Typically, the electrode restoration treatment is performed by cleaning the battery element 21 with a polar solvent to remove impurities contained in and/or attached to the battery element 21, followed by drying. The polar solvent may be any of a non-aqueous solvent and water. Examples of the non-aqueous solvent include NMP (N-methyl-2-pyrrolidone) and ethanol. The cleaning method with the polar solvent is not specifically limited, but it is preferable to immerse the battery element 21 in the polar solvent and perform ultrasonic cleaning or stirring.

It is preferable to heat, at 300 to 1000° C., the battery element 21 thus cleaned and dried, in that the electrode performance can be further enhanced. Since the battery element 21 in the present invention (except the positive electrode current collector 14 and/or the negative electrode current collector 18) is composed of ceramics alone, they can be subjected to heat treatment such as degreasing and firing (which cannot be applied to coating electrodes containing active materials and binders). In this case, the battery element 21 is preferably degreased and/or fired, more preferably both degreased and fired. The battery element 21 may be degreased by heating the battery element preferably at 300 to 600° C., more preferably at 400 to 600° C., and the preferable retention time in the aforementioned temperature range is 0.5 to 20 hours, more preferably 2 to 20 hours. As a result, unnecessary components or impurities (SEI or the like) remaining in the battery element 21 can be eliminated or burned off, the residual amount can be further reduced, and the battery performance can be further improved. The battery element 21 may be fired by heating the battery element preferably at 650 to 1000° C., more preferably at 700 to 950° C., and the preferable retention time in the aforementioned temperature range is 0.01 to 20 hours, more preferably 0.01 to 15 hours. Thus, the crystallinity of the substance can be restored or improved, and the battery performance can be further enhanced. Further, sintering the electrode active material more can improve the strength of the electrode active material layer. In addition, it is also possible to optimize the lithium content in the electrode active materials and promote the restoration of the performance of the positive electrode layer 12 and/or the negative electrode layer 16 by coexistence of a lithium compound and/or lithium-containing atmosphere in heat treatment such as degreasing and firing.

In the case where the battery element 21 further includes the positive electrode current collector 14 and/or the negative electrode current collector 18, it is preferable to detach the positive electrode current collector 14 and/or the negative electrode current collector 18 before and/or during the cleaning and attach the positive electrode current collector 14 and/or the negative electrode current collector 18 to the battery element 21 after the electrode restoration treatment. Thus, ceramics alone can be subjected to the cleaning or heat treatment as described above. The positive electrode current collector 14 and/or the negative electrode current collector 18 attached to the battery element 21 after the electrode restoration treatment are not limited to a new positive electrode current collector 14 and/or a new negative electrode current collector 18, and the positive electrode current collector 14 and/or the negative electrode current collector 18 detached may be recycled.

(5) Battery Assembly

The battery element 21 subjected to the electrode restoration treatment is put back into the battery container 24 to assemble the lithium-ion secondary battery 10. At this time, at least some parts constituting the battery container 24 may be replaced with new parts. Alternatively, after the battery element 21 is taken out and before they are put back into the battery container 24, the battery container 24 may be replaced with another battery container 24.

Lithium-Ion Secondary Battery

As shown in FIG. 1, the lithium-ion secondary battery 10 includes the ceramic positive electrode layer 12 (which will be hereinafter referred to as the positive electrode layer 12), the ceramic negative electrode layer 16 (which will be hereinafter referred to as the negative electrode layer 16), the ceramic separator 20 (which will be hereinafter referred to as the separator 20), the electrolytic solution 22, and the battery container 24. The positive electrode layer 12 is composed of ceramics such as a lithium complex oxide sintered body. The negative electrode layer 16 is composed of ceramics such as a titanium-containing sintered body. The separator 20 is interposed between the positive electrode layer 12 and the negative electrode layer 16. The positive electrode layer 12, the negative electrode layer 16, and the separator 20 are impregnated with the electrolytic solution 22. The battery container 24 has a closed space, and the positive electrode layer 12, the negative electrode layer 16, the separator 20, and the electrolytic solution 22 are accommodated in the closed space.

The positive electrode layer 12 is composed of a lithium complex oxide sintered body. The fact that the positive electrode layer 12 is composed of a sintered body means that the positive electrode layer 12 is free from binders or conductive additives. This is because, even if a binder is contained in a green sheet, the binder disappears or burns out during firing. Since the positive electrode layer 12 contains no binder, there is an advantage that deterioration of the positive electrode due to the electrolytic solution 22 can be avoided. The lithium complex oxide constituting the sintered body is particularly preferably lithium cobaltite (typically, LiCoO₂, which may be hereinafter abbreviated as LCO). Various lithium complex oxide sintered plates or LCO sintered plates are known, and those disclosed in Patent Literature 6 (JP6374634B) can be referred to, for example.

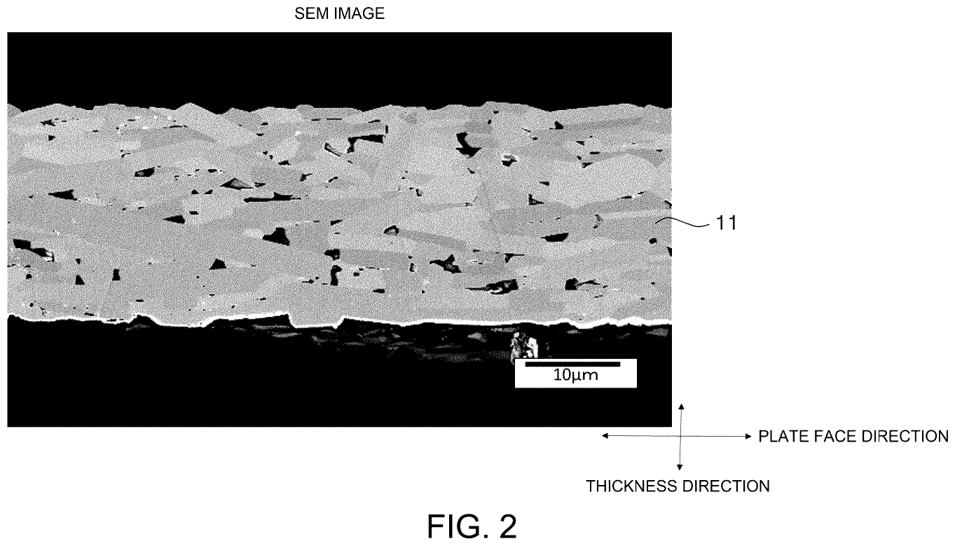

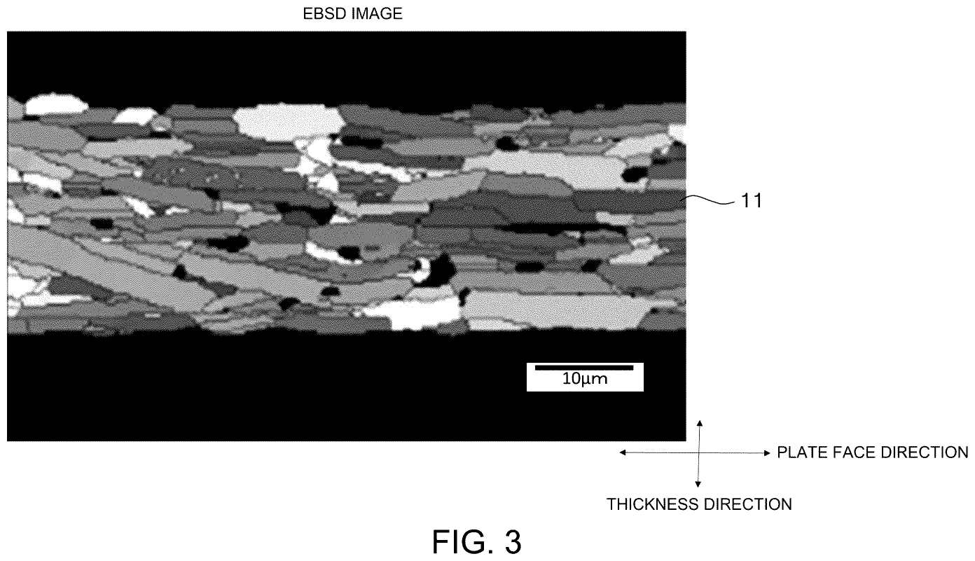

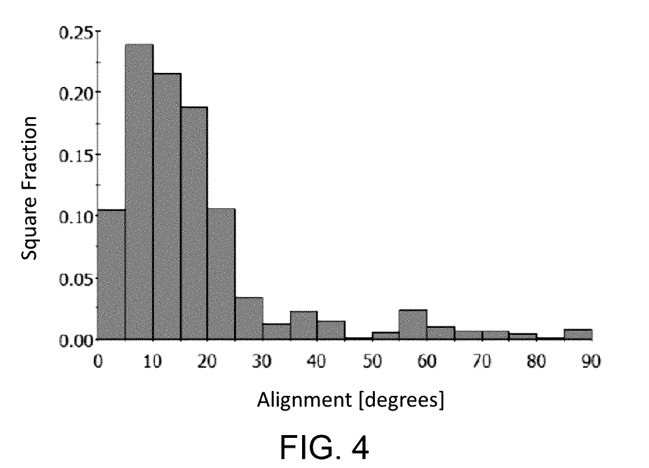

According to a preferable aspect of the present invention, the positive electrode layer 12, that is, the lithium complex oxide sintered plate is an oriented positive electrode layer including a plurality of primary grains composed of lithium complex oxide, the plurality of primary grains being oriented at an average orientation angle of over 0° and 30° or less to the layer face of the positive electrode layer. Since the oriented positive electrode layer is oriented as described above, it is particularly suitable for reuse because it is less susceptible to structural damage due to expansion and contraction associated with charging and discharging. FIG. 2 shows an example of a SEM image in a cross section perpendicular to the layer face of the oriented positive electrode layer 12, and FIG. 3 shows an electron backscatter diffraction (EBSD: Electron Backscatter Diffraction) image in a cross section perpendicular to the layer face of the oriented positive electrode layer 12. Further, FIG. 4 shows an area-based histogram showing the distribution of orientation angles of primary grains 11 in the EBSD image shown in FIG. 3. In the EBSD image shown in FIG. 3, the discontinuity of crystal orientation can be observed. In FIG. 3, the orientation angle of each primary grain 11 is indicated by the shading of color. A darker color indicates a smaller orientation angle. The orientation angle is a tilt angle formed by plane (003) of the primary grains 11 to the layer face direction. In FIGS. 2 and 3, the points shown in black within the oriented positive electrode layer 12 represent pores.

The oriented positive electrode layer 12 is an oriented sintered body composed of the plurality of primary grains 11 bound to each other. The primary grains 11 are each mainly in the form of a plate but may include rectangular, cubic, and spherical grains. The cross-sectional shape of each primary grain 11 is not particularly limited and may be a rectangular shape, a polygonal shape other than the rectangular shape, a circular shape, an elliptical shape, or a complex shape other than above.

The primary grains 11 are composed of a lithium complex oxide. The lithium complex oxide is an oxide represented by LiₓMO₂ (where 0.05<x<1.10 is satisfied, M represents at least one transition metal, and M typically contains one or more of Co, Ni, and Mn). The lithium complex oxide has a layered rock-salt structure. The layered rock-salt structure refers to a crystalline structure in which lithium layers and transition metal layers other than lithium are alternately stacked with oxygen layers interposed therebetween, that is, a crystalline structure in which transition metal ion layers and single lithium layers are alternately stacked with oxide ions therebetween (typically, an α-NaFeO₂ structure, i.e., a cubic rock-salt structure in which transition metal and lithium are regularly disposed in the [111] axis direction). Examples of the lithium complex oxide include LiₓCoO₂ (lithium cobaltate), LiₓNiO₂ (lithium nickelate), LiₓMnO₂ (lithium manganate), LiₓNiMnO₂ (lithium nickel manganate), LiₓNiCoO₂ (lithium nickel cobaltate), LiₓCoNiMnO₂ (lithium cobalt nickel manganate), and LiₓCoMnO₂ (lithium cobalt manganate), particularly preferably LiₓCoO₂ (lithium cobaltate, typically LiCoO₂). The lithium complex oxide may contain one or more elements selected from Mg, Al, Si, Ca, Ti, V, Cr, Fe, Cu, Zn, Ga, Ge, Sr, Y, Zr, Nb, Mo, Ag, Sn, Sb, Te, Ba, Bi, and W.

As shown in FIGS. 3 and 4, the average of the orientation angles of the primary grains 11, that is, the average orientation angle is over 0° and 30° or less. This brings various advantages as follows. First, since each primary grain 11 lies in a direction inclined from the thickness direction, the adhesion between the primary grains can be improved. As a result, the lithium ion conductivity between a certain primary grain 11 and each of other primary grains 11 adjacent to the primary grain 11 on both sides in the longitudinal direction can be improved, so that the rate characteristic can be improved. Secondly, the rate characteristic can be further improved. This is because, when lithium ions move in and out, the oriented positive electrode layer 12 expands and contracts smoothly since the oriented positive electrode layer 12 expands and contracts more in the thickness direction than in the layer face direction, as described above, and thus the lithium ions also move in and out smoothly. Thirdly, since the expansion and contraction of the oriented positive electrode layer 12 following the inflow and outflow of lithium ions are predominant in the direction perpendicular to the layer face, stress is less likely to occur at the bonding interface between the oriented positive electrode layer 12 and the ceramic separator 20, thereby making it easy to maintain good bonding at the interface.

The average orientation angle of the primary grains 11 is obtained by the following method. First, three horizontal lines that divide the oriented positive electrode layer 12 into four equal parts in the thickness direction and three vertical lines that divide the oriented positive electrode layer 12 into four equal parts in the layer face direction are drawn in an EBSD image of a rectangular region of 95 μm×125 μm observed at a magnification of 1000 times, as shown in FIG. 3. Next, the average orientation angle of the primary grains 11 is obtained by arithmetically averaging the orientation angles of all the primary grains 11 intersecting at least one of the three horizontal lines and the three vertical lines. The average orientation angle of the primary grains 11 is preferably 30° or less, more preferably 25° or less, from the viewpoint of further improving the rate characteristics. From the viewpoint of further improving the rate characteristics, the average orientation angle of the primary grains 11 is preferably 2° or more, more preferably 5° or more.

As shown in FIG. 4, the orientation angles of the primary grains 11 may be widely distributed from 0° to 90°, but most of them are preferably distributed in the region of over 0° and 30° or less. That is, when a cross section of the oriented sintered body constituting the oriented positive electrode layer 12 is analyzed by EBSD, the total area of the primary grains 11 with an orientation angle of over 0° and 30° or less to the layer face of the oriented positive electrode layer 12 (which will be hereinafter referred to as low-angle primary grains) out of the primary grains 11 contained in the cross section analyzed is preferably 70% or more, more preferably 80% or more, with respect to the total area of the primary grains 11 contained in the cross section (specifically, 30 primary grains 11 used for calculating the average orientation angle). Thereby, the proportion of the primary grains 11 with high mutual adhesion can be increased, so that the rate characteristic can be further improved. Further, the total area of grains with an orientation angle of 20° or less among the low-angle primary grains is more preferably 50% or more with respect to the total area of 30 primary grains 11 used for calculating the average orientation angle. Further, the total area of grains with an orientation angle of 10° or less among the low-angle primary grains is more preferably 15% or more with respect to the total area of 30 primary grains 11 used for calculating the average orientation angle.

Since the primary grains 11 are each mainly in the form of a plate, the cross section of each primary grain 11 extends in a predetermined direction, typically in a substantially rectangular shape, as shown in FIGS. 2 and 3. That is, when the cross section of the oriented sintered body is analyzed by EBSD, the total area of the primary grains 11 with an aspect ratio of 4 or more in the primary grains 11 contained in the cross section analyzed is preferably 70% or more, more preferably 80% or more, with respect to the total area of the primary grains 11 contained in the cross section (specifically, 30 primary grains 11 used for calculating the average orientation angle). Specifically, in the EBSD image as shown in FIG. 3, the mutual adhesion between the primary grains 11 can be further improved by above, as a result of which the rate characteristic can be further improved. The aspect ratio of each primary grain 11 is a value obtained by dividing the maximum Feret diameter of the primary grain 11 by the minimum Feret diameter. The maximum Feret diameter is the maximum distance between two parallel straight lines that interpose the primary grain 11 therebetween on the EBSD image in observation of the cross section. The minimum Feret diameter is the minimum distance between two parallel straight lines that interpose the primary grain 11 therebetween on the EBSD image.

The mean diameter of the plurality of primary grains constituting the oriented sintered body is preferably 5 μm or more. Specifically, the mean diameter of the 30 primary grains 11 used for calculating the average orientation angle is preferably 5 μm or more, more preferably 7 μm or more, further preferably 12 μm or more. Thereby, since the number of grain boundaries between the primary grains 11 in the direction in which lithium ions conduct is reduced, and the lithium ion conductivity as a whole is improved, the rate characteristic can be further improved. The mean diameter of the primary grains 11 is a value obtained by arithmetically averaging the equivalent circle diameters of the primary grains 11. An equivalent circle diameter is the diameter of a circle having the same area as each primary grain 11 on the EBSD image.

The positive electrode layer 12 preferably includes pores. The electrolytic solution can penetrate into the sintered body by the sintered body including pores, particularly open pores, when the sintered body is integrated into a battery as a positive electrode plate. As a result, the lithium ion conductivity can be improved. This is because there are two types of conduction of lithium ions within the sintered body: conduction through constituent grains of the sintered body; and conduction through the electrolytic solution within the pores, and the conduction through the electrolytic solution within the pores is overwhelmingly faster.

The positive electrode layer 12, that is, the lithium complex oxide sintered body preferably has a porosity of 20 to 60%, more preferably 25 to 55%, further preferably 30 to 50%, particularly preferably 30 to 45%. The stress relief effect by the pores and the increase in capacity can be expected, and the mutual adhesion between the primary grains 11 can be further improved, so that the rate characteristics can be further improved. The porosity of the sintered body is calculated by polishing a cross section of the positive electrode layer with CP (cross-section polisher) polishing, thereafter observing the cross section at a magnification of 1000 times with SEM, and binarizing the SEM image obtained. The average equivalent circle diameter of pores formed inside the oriented sintered body is not particularly limited but is preferably 8 μm or less. The smaller the average equivalent circle diameter of the pores, the mutual adhesion between the primary grains 11 can be improved more. As a result, the rate characteristic can be improved more. The average equivalent circle diameter of the pores is a value obtained by arithmetically averaging the equivalent circle diameters of 10 pores on the EBSD image. An equivalent circle diameter is the diameter of a circle having the same area as each pore on the EBSD image. Each of the pores formed inside the oriented sintered body is preferably an open pore connected to the outside of the positive electrode layer 12.

The positive electrode layer 12, that is, the lithium complex oxide sintered body preferably has a mean pore diameter of 0.1 to 10.0 μm, more preferably 0.2 to 5.0 μm, further preferably 0.25 to 3.0 μm. Within such a range, stress concentration is suppressed from occurring locally in large pores, and the stress is easily released uniformly in the sintered body.

The positive electrode layer 12 preferably has a thickness of 60 to 450 μm, more preferably 70 to 350 μm, further preferably 90 to 300 μm. The thickness within such a range can improve the energy density of the lithium-ion secondary battery 10 by increasing the capacity of the active material per unit area together with suppressing the deterioration of the battery characteristics (particularly, the increase of the resistance value) due to repeated charging/discharging.

The negative electrode layer 16 is composed of a titanium-containing sintered body. The titanium-containing sintered body preferably contains lithium titanate Li₄Ti₅O₁₂ (which will be hereinafter referred to as LTO) or niobium titanium complex oxide Nb₂TiO₇, more preferably LTO. LTO is typically known to have a spinel structure but can have other structures during charging and discharging. For example, the reaction of LTO proceeds in the two-phase coexistence of Li₄Ti₅O₁₂ (spinel structure) and Li₇Ti₅O₁₂ (rock salt structure) during charging and discharging. Accordingly, the structure of LTO is not limited to the spinel structure.

The fact that the negative electrode layer 16 is composed of a sintered body means that the negative electrode layer 16 contains no binder or conductive agent. This is because, even if a binder is contained in a green sheet, the binder disappears or burns out during firing. Since the negative electrode layer contains no binder, high capacity and good charge/discharge efficiency can be achieved by high packing density of the negative electrode active material (for example, LTO or Nb₂TiO₇). The LTO sintered body can be produced according to the method described in Patent Literature 7 (JP6392493B).

The negative electrode layer 16, that is, the titanium-containing sintered body has a structure that a plurality (namely, a large number) of primary grains are bonded. Accordingly, these primary grains are preferably composed of LTO or Nb₂TiO₇.

The negative electrode layer 16 preferably has a thickness of 70 to 500 μm, preferably 85 to 400 μm, more preferably 95 to 350 μm. As the thickness of the negative electrode layer 16 increases, it is easier to achieve a battery with high capacity and high energy density. The thickness of the negative electrode layer 16 is determined by measuring the distance between the two substantially parallel faces of the layer, for example, when the cross section of the negative electrode layer 16 is observed by SEM (scanning electron microscopy).

The primary grain size that is the average grain size of the plurality of primary grains forming the negative electrode layer 16 is preferably 1.2 μm or less, more preferably 0.02 to 1.2 μm, further preferably 0.05 to 0.7 μm. Within such a range, the lithium ion conductivity and the electron conductivity are easily compatible with each other, which contributes to improving the rate performance. The negative electrode layer 16 preferably includes pores. The electrolytic solution can penetrate into the sintered body by the sintered body including pores, particularly open pores, when the sintered body is integrated into a battery as a negative electrode layer. As a result, the lithium ion conductivity can be improved. This is because there are two types of conduction of lithium ions within the sintered body: conduction through constituent grains of the sintered body; and conduction through the electrolytic solution within the pores, and the conduction through the electrolytic solution within the pores is overwhelmingly faster.

The negative electrode layer 16 preferably has a porosity of 20 to 60%, more preferably 30 to 55%, further preferably 35 to 50%. Within such a range, the lithium ion conductivity and the electron conductivity are easily compatible with each other, which contributes to improving the rate performance.

The negative electrode layer 16 has a mean pore diameter of 0.08 to 5.0 μm, preferably 0.1 to 3.0 μm, more preferably 0.12 to 1.5 μm. Within such a range, the lithium ion conductivity and the electron conductivity are easily compatible with each other, which contributes to improving the rate performance.

The separator 20 is a microporous film made of ceramic. The separator 20 is advantageous in that it, of course, has excellent heat resistance and can be produced as one integrated sintered plate together with the positive electrode layer 12 and the negative electrode layer 16 as a whole. The ceramic contained in the separator 20 is preferably at least one selected from MgO, Al₂O₃, ZrO₂, SiC, Si₃N₄, AlN, and cordierite, more preferably at least one selected from MgO, Al₂O₃, and ZrO₂. The separator 20 preferably has a thickness of 3 to 40 μm, more preferably 5 to 35 μm, further preferably 10 to 30 μm. The separator 20 preferably has a porosity of 30 to 85%, more preferably 40 to 80%.

The separator 20 may contain a glass component for improving the adhesion to the positive electrode layer 12 and the negative electrode layer 16. In this case, the content ratio of the glass component in the separator 20 is preferably 0.1 to 50 wt %, more preferably 0.5 to 40 wt %, further preferably 0.5 to 30 wt %, with respect to the total weight of the separator 20. The addition of the glass component to the separator 20 is preferably performed by adding glass frit to the raw material powder of the ceramic separator. However, if the desired adhesion of the separator 20 to the positive electrode layer 12 and the negative electrode layer 16 can be ensured, the glass component is not particularly required to be contained in the separator 20.

It is preferable that the positive electrode layer 12, the separator 20, and the negative electrode layer 16 form one integrated sintered plate as a whole, whereby the positive electrode layer 12, the separator 20, and the negative electrode layer 16 are bonded together. That is, the three layers of the positive electrode layer 12, the separator 20, and the negative electrode layer 16 are preferably bonded together without resorting to other bonding methods such as adhesives. Here, to “form one integrated sintered plate as a whole” means that green sheets having a three-layer structure composed of a positive electrode green sheet providing the positive electrode layer 12, a separator green sheet providing the separator 20, and a negative electrode green sheet providing the negative electrode layer 16 are fired, so that each layer is sintered. Therefore, if the green sheets with a three-layer structure before firing are punched into a predetermined shape (such as a coin shape and a chip shape) using a punching die, the displacement between the positive electrode layer 12 and the negative electrode layer 16 in the integrated sintered plate in the final form is supposed not to exist at all. That is, the end face of the positive electrode layer 12 and the end face of the negative electrode layer 16 are aligned, so that the capacity can be maximized. Alternatively, even if such a displacement is present, the integrated sintered plate is suitable for processing such as laser processing, cutting, and polishing. Therefore, the end face may be finished to minimize or eliminate such a displacement. In any case, the positive electrode layer 12, the separator 20, and the negative electrode layer 16 are bonded together, as long as they form an integrated sintered plate, the displacement between the positive electrode layer 12 and the negative electrode layer 16 never occurs afterwards. The high discharge capacity, as expected (that is, close to the theoretical capacity), can be achieved by minimizing or eliminating the displacement between the positive electrode layer 12 and the negative electrode layer 16. Further, it is considered that, since the integrated sintered plate has a three-layer structure including the ceramic separator, waviness or warpage is less likely to occur (that is, the flatness is excellent), and therefore variations in the distance between the positive and negative electrodes are less likely to occur (that is, the distance is uniform), as compared with a single positive electrode plate and a single negative electrode plate that are each produced as one sintered plate, thereby contributing to improving the charge/discharge cycle performance. Such an integrated sintered body can be produced according to the method described in Patent Literature 8 (WO2019/221140A1).

The electrolytic solution 22 is not specifically limited, and commercially available electrolytic solutions for lithium batteries such as a solution obtained by dissolving a lithium salt (e.g., LiPF₆) in a non-aqueous solvent such as an organic solvent (e.g., a mixed solvent of ethylene carbonate (EC) and methyl ethyl carbonate (MEC), a mixed solvent of ethylene carbonate (EC) and diethyl carbonate (DEC), or a mixed solvent of ethylene carbonate (EC) and ethyl methyl carbonate (EMC)) may be used.

In the case of forming a lithium-ion secondary battery having excellent heat resistance, the electrolytic solution 22 preferably contains lithium borofluoride (LiBF4) in a non-aqueous solvent. In this case, the non-aqueous solvent is preferably at least one selected from the group consisting of γ-butyrolactone (GBL), ethylene carbonate (EC) and propylene carbonate (PC), more preferably a mixed solvent composed of EC and GBL, a single solvent composed of PC, a mixed solvent composed of PC and GBL, or a single solvent composed of GBL, particularly preferably a mixed solvent composed of EC and GBL or a single solvent composed of GBL. The non-aqueous solvent has an increased boiling point by containing y-butyrolactone (GBL), which considerably improves the heat resistance. From such a viewpoint, the volume ratio of EC:GBL in the EC and/or GBL containing non-aqueous solvent is preferably 0:1 to 1:1 (GBL ratio: 50 to 100% by volume), more preferably 0:1 to 1:1.5 (GBL ratio: 60 to 100% by volume), further preferably 0:1 to 1:2 (GBL ratio: 66.6 to 100% by volume), particularly preferably 0:1 to 1:3 (GBL ratio: 75 to 100% by volume). The lithium borofluoride (LiBF₄) to be dissolved in the non-aqueous solvent is an electrolyte having a high decomposition temperature, which also considerably improves the heat resistance. The LiBF₄ concentration in the electrolytic solution 22 is preferably 0.5 to 2 mol/L, more preferably 0.6 to 1.9 mol/L, further preferably 0.7 to 1.7 mol/L, particularly preferably 0.8 to 1.5 mol/L.

The electrolytic solution 22 may further contain vinylene carbonate (VC) and/or fluoroethylene carbonate (FEC) and/or vinyl ethylene carbonate (VEC) as additives. Both VC and FEC have excellent heat resistance. Accordingly, a SEI film having excellent heat resistance can be formed on the surface of the negative electrode layer 16 by the electrolytic solution 22 containing such additives.

The battery container 24 includes a closed space, and the closed space accommodates the positive electrode layer 12, the negative electrode layer 16, the separator 20, and the electrolytic solution 22. The battery container 24 may be appropriately selected corresponding to the type of the lithium-ion secondary battery 10. For example, in the case where the lithium-ion secondary battery is in a form of coin-shaped battery as shown in FIG. 1, the battery container 24 typically includes the positive electrode can 24a, the negative electrode can 24b, and the gasket 24c, and the positive electrode can 24a and the negative electrode can 24b are crimped via the gasket 24c to form the closed space. The positive electrode can 24a and the negative electrode can 24b can be made of metals such as stainless steel and are not specifically limited. The gasket 24c can be an annular member made of an insulating resin such as polypropylene, polytetrafluoroethylene, and PFA resin and is not particularly limited.

The lithium-ion secondary battery 10 preferably further includes a positive electrode current collector 14 and/or a negative electrode current collector 18. The positive electrode current collector 14 and the negative electrode current collector 18 are not specifically limited but are preferably metal foils such as copper foils and aluminum foils. The positive electrode current collector 14 is preferably interposed between the positive electrode layer 12 and the battery container 24 (e.g., the positive electrode can 24a), and the negative electrode current collector 18 is preferably interposed between the negative electrode layer 16 and the battery container 24 (e.g., the negative electrode can 24b). Further, a positive side carbon layer 13 is preferably provided between the positive electrode layer 12 and the positive electrode current collector 14 for reducing the contact resistance. Likewise, a negative side carbon layer 17 is preferably provided between the negative electrode layer 16 and the negative electrode current collector 18 for reducing the contact resistance. Both the positive side carbon layer 13 and the negative side carbon layer 17 are preferably composed of a conductive carbon and may be formed, for example, by applying a conductive carbon paste by screen printing or the like.

The battery element may be in the form of a cell laminate comprising a plurality of unit cells each containing the positive electrode layer 12, the separator 20, and the negative electrode layer 16. The cell laminate is not limited to a flat plate laminated structure in the form of stacked flat plates or layers and can be various laminated structures including the following examples. In any of the configurations mentioned below, the cell laminate as a whole is preferably one integrated sintered body.
Folded structure: A laminated structure in which a sheet having a layer structure including unit cells and current collecting layers is folded back once or multiple times to form a multi-layered structure (increased area).
Wound structure: A laminated structure in which a sheet having a layer structure including unit cells and current collecting layers is wound and integrated to form a multi-layered structure (increased area).
Multilayer ceramic capacitor (MLCC)-like structure: A laminated structure in which the lamination unit of current collecting layer/positive electrode layer/ceramic separator layer/negative electrode layer/current collecting layer is repeated in the thickness direction to form multiple layers (increased area), a plurality of positive electrode layers are collected on one side (e.g., left side), and a plurality of negative electrode layers are collected on the other side (e.g., right side).

### EXAMPLES

The invention will be illustrated in more detail by the following examples. In the following examples, LiCoO₂ will be abbreviated as “LCO”, and Li₄Ti₅O₁₂ will be abbreviated as “LTO”.

### Example 1

(1) Preparation of LCO Green Sheet (Positive Electrode Green Sheet)

First, Co₃O₄ powder (manufactured by SEIDO CHEMICAL INDUSTRY CO., LTD.) and Li₂CO₃ powder (manufactured by THE HONJO CHEMICAL CORPORATION) weighed to a molar ratio Li/Co of 1.01 were mixed, and thereafter the mixture was kept at 780° C. for 5 hours. The resultant powder was milled into a volume-based D50 of 0.4 μm with a pot mill to yield powder composed of platy LCO particles. The resultant LCO powder (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (10 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. The resultant mixture was defoamed by stirring under reduced pressure to prepare a LCO slurry with a viscosity of 4000 cP. The viscosity was measured with an LVT viscometer manufactured by Brookfield. The slurry prepared was formed into a LCO green sheet onto a PET film by a doctor blade process. The thickness of the LCO green sheet was adjusted to 60 μm after firing.

(2) Preparation of LTO Green Sheet (Negative Electrode Green Sheet)

First, LTO powder (volume-based D50 particle size: 0.06 μm, manufactured by Sigma-Aldrich Japan) (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (20 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. The resultant negative electrode raw material mixture was defoamed by stirring under reduced pressure to prepare a LTO slurry with a viscosity of 4000 cP. The viscosity was measured with an LVT viscometer manufactured by Brookfield. The slurry prepared was formed into a LTO green sheet onto a PET film by a doctor blade process. The thickness of the LTO green sheet was adjusted to 70 μm after firing.

(3) Preparation of MgO Green Sheet (Separator Green Sheet)

Magnesium carbonate powder (manufactured by Konoshima Chemical Co., Ltd.) was heated at 900° C. for 5 hours to obtain MgO powder. The resultant MgO powder and glass frit (CK0199, manufactured by Nippon Frit Co., Ltd. (currently, TAKARA STANDARD CO., LTD.)) were mixed at a weight ratio of 4:1. The resultant mixed powder (volume-based D50 particle size: 0.4 μm) (100 parts by weight), a dispersive medium (toluene:isopropanol=1:1) (100 parts by weight), a binder (polyvinyl butyral: Product No. BM-2, manufactured by SEKISUI CHEMICAL CO., LTD.) (20 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. The resultant raw material mixture was defoamed by stirring under reduced pressure to prepare a slurry with a viscosity of 4000 cP. The viscosity was measured with an LVT viscometer manufactured by Brookfield. The slurry prepared was formed into a separator green sheet onto a PET film by a doctor blade process. The thickness of the separator green sheet was adjusted to 25 μm after firing.

(4) Lamination, Pressure Bonding, and Firing

The LCO green sheet (positive electrode green sheet), the MgO green sheet (separator green sheet), and the LTO green sheet (negative electrode green sheet) were sequentially stacked, and the resultant laminate was pressed by CIP (cold isostatic pressing) at 200 kgf/cm² so that the green sheets were pressure-bonded together. The laminate thus pressure-bonded was punched into a circular plate with a diameter of 10 mm using a punching die. The resultant laminate in a form of circular plate was degreased at 600° C. for 5 hours, then heated to 800° C. at 1000° C./h, and kept for 10 minutes to fire, followed by cooling. Thus, one integrated sintered plate including three layers of a positive electrode layer (LCO sintered layer), a ceramic separator (MgO separator), and a negative electrode layer (LTO sintered layer) was obtained.

(5) Production of Lithium-Ion Secondary Battery

The coin-shaped lithium-ion secondary battery 10 as schematically shown in FIG. 1 was produced as follows.

(5a) Adhesion of Negative Electrode Layer and Negative Electrode Current Collector with Conductive Carbon Paste

Acetylene black and polyimide amide were weighed to a mass ratio of 3:1 and mixed with an appropriate amount of NMP (N-methyl-2-pyrrolidone) as a solvent, to prepare a conductive carbon paste as a conductive adhesive. The conductive carbon paste was screen-printed on an aluminum foil as a negative electrode current collector. The integrated sintered body produced in (4) above was disposed so that the negative electrode layer was located within an undried printing pattern (that is, a region coated with the conductive carbon paste), followed by vacuum drying at 60° C. for 30 minutes, to produce a structure with the negative electrode layer and the negative electrode current collector bonded via the negative side carbon layer. The negative side carbon layer had a thickness of 10 μm.

(5b) Preparation of Positive Electrode Current Collector with Carbon Layer

Acetylene black and polyimide amide were weighed to a mass ratio of 3:1 and mixed with an appropriate amount of NMP (N-methyl-2-pyrrolidone) as a solvent, to prepare a conductive carbon paste. The conductive carbon paste was screen-printed on an aluminum foil as a positive electrode current collector, followed by vacuum drying at 60° C. for 30 minutes, to produce a positive electrode current collector with a positive side carbon layer formed on a surface. The positive side carbon layer had a thickness of 5 μm.

(5c) Assembling of Coin-Shaped Battery

The positive electrode current collector, the positive side carbon layer, the integrated sintered plate (the LCO positive electrode layer, the MgO separator, and the LTO negative electrode layer), the negative side carbon layer, and the negative electrode current collector were accommodated between the positive electrode can and the negative electrode can, which would form a battery case, so as to be stacked in this order from the positive electrode can toward the negative electrode can, and an electrolytic solution was filled therein. Thereafter, the positive electrode can and the negative electrode can were crimped via a gasket to be sealed. Thus, the coin cell-shaped lithium-ion secondary battery 10 with a diameter of 12 mm and a thickness of 1.0 mm was produced. At this time, the electrolytic solution was a solution of LiBF₄ (1.5 mol/L) in a mixed organic solvent of ethylene carbonate (EC) and γ-butyrolactone (GBL) at 1:3 (volume ratio).

(6) Measurement of Capacity Retention Rate After Storage

The capacity retention rate after storage of the battery was measured by the following procedure. First, the battery was charged at a constant voltage of 2.7 V in an environment of 25° C. and then discharged at a discharge rate of 0.2 C to measure the initial capacity. Then, a voltage of 2.7 V was applied in an environment of 60° C. and held for 50 days. Finally, the battery was charged at a constant voltage of 2.7 V and then discharged at 0.2 C to measure the capacity after storage. The measured capacity after storage was divided by the initial capacity and multiplied by 100 to obtain a capacity retention rate (%) after storage.

(7) Disassembly, Cleaning, and Reassembly of Battery After Storage

A battery discharged after storage was prepared, and the sealing part which crimped the positive electrode can and the negative electrode can was opened. Then, the negative electrode can and the gasket were detached from the battery, and the positive electrode current collector, the integrated sintered plate, and the negative electrode current collector were taken out from the inside. Then, the positive electrode current collector was detached from the integrated sintered plate taken out, the integrated sintered plate with the negative electrode current collector attached was immersed in an appropriate amount of NMP (N-methyl-2-pyrrolidone) followed by stirring for 60 minutes, to dissolve and remove impurities such as the positive electrode carbon layer and the negative electrode carbon layer adhering to the integrated sintered plate and the electrolytic solution decomposition product adhering to the integrated sintered plate while separating the negative electrode current collector. The same operation was repeated twice, and the integrated sintered plate from which impurities have been removed was vacuum-dried at 120° C. for 12 hours. Then, the vacuum-dried integrated sintered plate was reassembled as a coin-shaped battery by the procedures (5a), (5b), and (5c) above.

(8) Capacity Retention Rate of Reassembled Battery

The capacity retention rate of the reassembled battery was measured by the following procedures. First, the battery was charged at a constant voltage of 2.7 V in an environment of 25° C. and then discharged at a discharge rate of 0.2 C to measure the capacity after reassembly. The measured capacity after reassembly was divided by the initial capacity and multiplied by 100 to obtain a capacity retention rate (%) after reassembly.

### Example 2

A reassembled battery was evaluated in the same manner as in Example 1, except that a vacuum-dried integrated sintered plate degreased by heating at 600° C. for 5 hours was used for reassembling the battery.

### Example 3

A reassembled battery was evaluated in the same manner as in Example 2, except that a degreased integrated sintered plate fired at 800° C. for 10 minutes was used for reassembling the battery.

### Example 4 (Comparison)

A reassembled battery was evaluated in the same manner as in Example 1, except that only the electrolytic solution was replaced without the electrode restoration treatment (cleaning and drying) after disassembling the battery.

### Example 5 (Comparison)

A battery was produced in the same manner as in Example 1, except that a) a commercially available LCO-coated electrode (manufactured by Hohsen Corp.) was used as a positive electrode plate instead of the LCO sintered plate, b) a carbon-coated electrode on a negative electrode current collector produced by the following procedure was used as a negative electrode plate and a negative electrode current collector, and c) a cellulose separator was used as a separator. Further, the battery was evaluated in the same manner as in Example 1 except that the charging voltage and the applied voltage during storage were changed to 4.2 V.

(Production of Carbon-Coated Electrode)

A paste containing a mixture of graphite as an active material and polyvinylidene fluoride (PVDF) as a binder was applied to a surface of a negative electrode current collector (aluminum foil), followed by drying, to produce a carbon-coated electrode including a carbon layer with a thickness of 280 μm.

Evaluation Results

Table 1 shows the evaluation results for Examples 1 to 5.

TABLE 1

| | | Electrode restoration treatment | | | Evaluation | |
|---|---|---|---|---|---|---|
| | | Cleaning | | | Capacity retention | Capacity retention |
| | Type of | and | | | rate after | rate after |
| | electrode | drying | Degreasing | Firing | storage (%) | reassembly (%) |
| Ex. 1 | Ceramic | Done | None | None | 82 | 92 |
| | electrode | | | | | |
| Ex. 2 | Ceramic | Done | Done | None | 83 | 94 |
| | electrode | | | | | |
| Ex. 3 | Ceramic | Done | Done | Done | 82 | 95 |
| | electrode | | | | | |
| Ex. 4* | Ceramic | None | None | None | 82 | 84 |
| | electrode | | | | | |
| Ex. 5* | Coated | Done | None | None | 71 | 30 |
| | electrode | | | | | |

The symbol * indicates a comparative example.

As seen from the results shown in Table 1, the capacity retention rate was significantly restored due to the effect of removing impurities by the electrode restoration treatment or the like in Examples 1 to 3. Meanwhile, the capacity retention rate was not significantly improved in Example 4 that is a comparative example in which only the electrolytic solution was replaced. Further, deterioration due to separation of the active material or the like occurred in the cleaning step in Example 5 that is a comparative example in which a coated electrode (containing binders or the like) was used.

### Example 6

(1) Production of Various Green Sheets

Various green sheets to constitute a laminate were produced, as follows. The viscosity of each slurry mentioned in the production of the green sheet was measured with a LVT-type viscometer, manufactured by AMETEK Brookfield. The doctor blade method was used to form the slurry on the PET film.

(1a) Preparation of LCO Green Sheet (Positive Electrode Green Sheet)

Co₃O₄ powder (manufactured by SEIDO CHEMICAL INDUSTRY CO., LTD.) and Li₂CO₃ powder (manufactured by THE HONJO CHEMICAL CORPORATION) weighed to a molar ratio Li/Co of 1.01 were mixed, and thereafter the mixture was kept at 780° C. for 5 hours. The resultant powder was milled into a volume-based D50 of 0.4 μm with a pot mill to obtain powder composed of platy LCO particles. The resultant LCO powder (100 parts by weight), a dispersive medium (toluene:isopropanol=1:1) (100 parts by weight), a binder (polyvinyl butyral: Product No. BM-2, manufactured by Sekisui Chemical Co., Ltd.) (8 parts by weight), a plasticizer (DOP: Di(2-ethylhexyl)phthalate, manufactured by Kurogane Kasei Co., Ltd.) (2 parts by weight), and a dispersant (product name: RHEODOL SP-O30, manufactured by Kao Corporation) (4.5 parts by weight) were mixed. The resultant mixture was defoamed by stirring under reduced pressure to prepare an LCO slurry with a viscosity of 4000 cP. An LCO green sheet was formed by shaping the slurry prepared on a PET film into a sheet. The thickness after firing of the LCO layer was adjusted to 12 μm.

(1b) Preparation of LTO Green Sheet (Negative Electrode Green Sheet)

LTO powder (volume-based D50 particle size 0.06 μm, manufactured by Sigma-Aldrich Japan) (100 parts by weight), a dispersion medium (toluene:isopropanol=1:1) (100 parts by weight), a binder (polyvinyl butyral: Product No. BM-2, manufactured by SEKISUI CHEMICAL CO., LTD.) (20 parts by weight), a plasticizer (DOP: Di(2-ethylhexyl)phthalate, manufactured by Kurogane Kasei Co., Ltd.) (4 parts by weight), and a dispersant (product name: RHEODOL SP-O30, manufactured by Kao Corporation) (2 parts by weight) were mixed. The resultant negative electrode raw material mixture was defoamed by stirring under reduced pressure to prepare a LTO slurry with a viscosity of 4000 cP. An LCO green sheet was formed by shaping the slurry prepared on a PET film into a sheet. The thickness of the LCO layer after firing was adjusted to 10 μm.

(1c) Formation of Current Collector Layer

An Au paste (product name: GB-2706, manufactured by TANAKA Kikinzoku Kogyo K. K.) was printed on one side of an LTO green sheet produced by the procedure (1b) with a printer. The thickness of the printed layer was adjusted to after firing 0.2 μm.

(1d) Production of Separator Green Sheet

Magnesium carbonate powder (manufactured by Konoshima Chemical Co., Ltd.) was heat-treated at 900° C. for 5 hours to obtain MgO powder. The MgO powder obtained and a glass frit (CK0199, manufactured by Nippon Frit Co., Ltd. (currently, TAKARA STANDARD CO., LTD.)) were mixed at a weight ratio of 7:3. 100 parts by weight of the mixed powder (volume-based D50 particle size 0.4 μm) obtained, 100 parts by weight of a dispersion medium (toluene:isopropanol=1:1), 30 parts by weight of a binder (polyvinyl butyral: product number BM-2, manufactured by SEKISUI CHEMICAL CO., LTD.), 6 parts by weight of a plasticizer (DOP: Di(2-ethylhexyl) phthalate, manufactured by Kurogane Kasei Co., Ltd.), and 2 parts by weight of a dispersant (product name: RHEODOL SP-O30, manufactured by Kao Corporation) were mixed. The raw material mixture obtained was stirred under reduced pressure for defoaming, and the viscosity was adjusted to 4000 cP, to prepare a slurry. A separator green sheet was formed by shaping the slurry prepared into a sheet on a PET film. The thickness of the separator layer after firing was adjusted to 25 μm.

(1e) Production of First Insulating Layer (Positive Electrode Insulating Layer) Green Sheet

Magnesium carbonate powder (manufactured by Konoshima Chemical Co., Ltd.) was heat-treated at 900° C. for 5 hours to obtain MgO powder. The MgO powder obtained and TiO2 (manufactured by ISHIHARA SANGYO KAISHA, LTD., CR-EL) were mixed at a weight ratio of 6:4. 100 parts by weight of the mixed powder (volume-based D50 particle size 0.4 μm) obtained, 100 parts by weight of a dispersion medium (toluene:isopropanol=1:1), 30 parts by weight of a binder (polyvinyl butyral: product number BM-2, manufactured by SEKISUI CHEMICAL CO., LTD.), 6 parts by weight of a plasticizer (DOP:Di(2-ethylhexyl)phthalate, manufactured by Kurogane Kasei Co., Ltd.), and 2 parts by weight of a dispersant (product name: RHEODOL SP-O30, manufactured by Kao Corporation) were mixed. The raw material mixture obtained was stirred under reduced pressure defoaming, and the viscosity was adjusted to 4000 cP, to prepare a slurry. A first insulating layer green sheet was formed by shaping the slurry prepared into a sheet on a PET film. The thickness of the first insulating layer after firing was adjusted to 12 μm.

(1f) Production of Second Insulating Layer (Negative Electrode Insulating Layer) Green Sheet

In the same manner as in the procedure (1e), a slurry was prepared. A second insulating layer green sheet was formed by shaping the slurry prepared into a sheet on a PET film. The thickness of the second insulating layer after firing was adjusted to 10 μm.

(2) Sheet Cutting

Various green sheets produced by the procedure (1) each were cut into a sheet piece with a width shown below.
LCO green sheet (positive electrode green sheet): 7460 μm
LTO green sheet (negative electrode green sheet): 7460 μm
Separator green sheet: 10000 μm
First insulating layer (positive electrode insulating layer) green sheet: 2540 μm
Second insulating layer (negative electrode insulating layer) green sheet: 2540 μm

(3) Lamination, Pressure Bonding, Cutting, and Firing

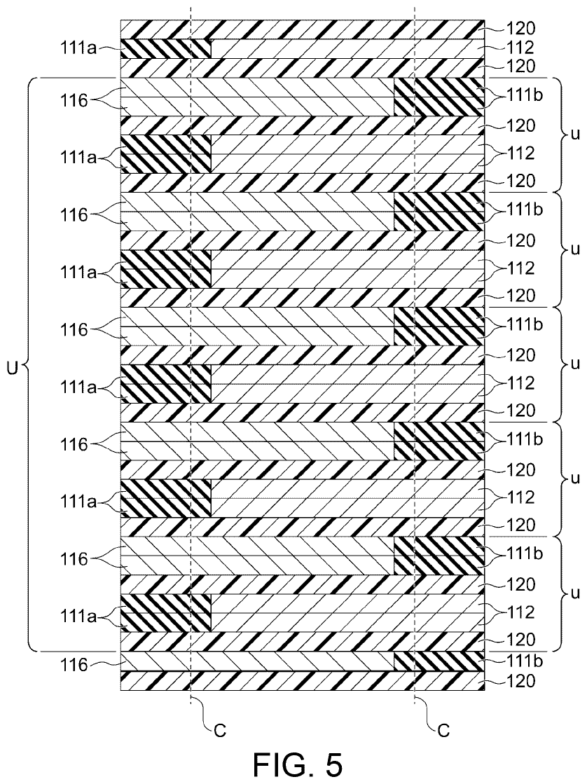

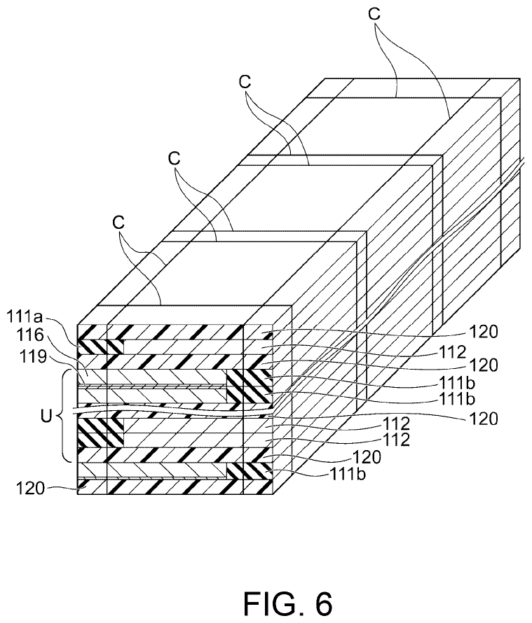

An LCO green sheet (positive electrode green sheet) 112, an LTO green sheet (negative electrode green sheet) 116, a separator green sheet 120, a first insulating layer (positive electrode insulating layer) green sheet 111a, and a second insulating layer (negative electrode insulating layer) green sheet 111b were laminated to give a layer structure as shown in FIGS. 5 and 6. The layer structure shown in FIG. 5 has five units u in total each containing an LCO green sheet 112, an LTO green sheet 116, a separator green sheet 120, and first and second insulating layer green sheets 111a and 111b, and those five lamination units U are schematically shown in FIG. 6. In the case where two pieces of the LTO green sheet 116 are layered, current collector layers 119 (which are omitted in FIG. 5, see FIG. 6 for reference) are laminated so as to be in contact with each other. The resulting laminate was pressed to pressure-bond green sheets each other by CIP (cold isostatic pressing) at 100 kgf/cm², to obtain an unfired green sheet laminate. Subsequently, the unfired green sheet laminate was cut along the cutting line C with a Thomson blade, as shown in FIGS. 5 and 6. At this time, the portions to 2500 μm from both ends in the width direction of the laminate were removed, and the laminate was cut to have a length of 5000 μm in the depth direction. Firing in which the unfired laminate after cutting was heated from room temperature to 600° C. for degreasing for 5 hours, heated to 800° C., and held for 10 minutes was performed, followed by cooling. Thus, an integrated sintered laminate was obtained. The number of cells formed in the integrated sintered laminate was 11.

(4) Preparation of Conductive Carbon Paste

A binder (CMC: MAC350HC, manufactured by Nippon Paper Industries Co., Ltd.) was weighed to 1.2 wt % with respect to pure water, dissolved therein by mixing with a stirrer, to obtain a 1.2 wt % CMC solution. A carbon dispersion (product number: BPW-229, manufactured by Nippon Graphite Industries, Co., Ltd.) and a dispersant solution (product number LB-300, manufactured by Showa Denko K. K.) were prepared. Subsequently, the carbon dispersion, the dispersant solution, and the 1.2 wt % CMC solution were weighed to 0.22:0.29:1 and mixed with a revolving mixer, to prepare a conductive carbon paste.

(5) Adhesion of Aluminum Foil to Positive Electrode-Exposed Surface of the Integrated Sintered Laminate

The conductive carbon paste obtained by the procedure (4) was screen-printed on an aluminum foil as a positive electrode current collector. The integrated sintered laminate obtained by the procedure (3) was placed so that the positive electrode-exposed surface adheres within the undried print pattern (the region where the conductive carbon paste was applied), which was lightly pressed with a finger and then vacuum-dried at 50° C. for 60 minutes. Thus, the positive electrode-exposed surface of the integrated sintered laminate and the positive electrode current collector adhered to each other with the conductive carbon adhesive layer interposed therebetween. The conductive carbon adhesive layer had a thickness of 30 μm.

(6) Adhesion of Aluminum Foil to Negative Electrode-Exposed Surface of Integrated Sintered Laminate

In the same manner as in the procedure (5), the aluminum foil of the negative electrode current collector adhered to the negative electrode-exposed surface of the integrated sintered laminate with the conductive carbon adhesive layer interposed therebetween.

(7) Assembly of Coin-Shaped Battery

The positive electrode current collector, the integrated sintered laminate, and the negative electrode current collector were accommodated so as to be laminated in this order from the positive electrode can toward the negative electrode can between the positive electrode can and the negative electrode can to constitute the battery case, which was filled with the electrolytic solution, and the positive electrode can and the negative electrode can were crimped via a gasket for sealing. Thus, a coin cell-type lithium secondary battery with a diameter of 20 mm and a thickness of 1.6 mm was produced. The electrolytic solution used was a solution in which LiPF₆ was dissolved in an organic solvent of propylene carbonate (PC) and γ-butyrolactone (GBL) mixed at a volume ratio of 1:3 to a concentration of 1.5 mol/L.

(8) Measurement of Capacity Retention Rate After Storage

The capacity retention rate after storage of the battery was measured by the following procedures. First, the battery was charged at a constant voltage of 2.7 V in an environment of 25° C. and then discharged at a discharge rate of 0.2 C to measure the initial capacity. Then, a voltage of 2.7 V was applied in an environment of 60° C. and held for 50 days. Finally, the battery was charged at a constant voltage of 2.7 V and then discharged at 0.2 C to measure the capacity after storage. The measured capacity after storage was divided by the initial capacity and multiplied by 100 to obtain a capacity retention rate (%) after storage.

(9) Disassembly, Cleaning, and Reassembly of Battery After Storage

A battery discharged after storage was prepared, and the sealing part which crimped the positive electrode can and the negative electrode can was opened. Then, the negative electrode can and the gasket were detached from the battery, and the positive electrode current collector, the integrated sintered laminate, and the negative electrode current collector were taken out from the inside. Then, the integrated sintered laminate taken out was immersed in an appropriate amount of NMP (N-methyl-2-pyrrolidone) followed by stirring for 60 minutes, to dissolve and remove impurities such as the positive electrode side carbon layer and the negative electrode side carbon layer adhering to the integrated sintered plate, and the electrolytic solution decomposition product adhering to the integrated sintered laminate, while separating the positive electrode current collector and the negative electrode current collector. The same operation was repeated twice, and the integrated sintered plate from which impurities have been removed was vacuum-dried at 120° C. for 12 hours. Then, the vacuum-dried integrated sintered plate was reassembled as a coin-shaped battery by the procedures (5), (6), and (7) above.

(10) Capacity Retention Rate of Reassembled Battery

The capacity retention rate of the reassembled battery was measured by the following procedures. First, the battery was charged at a constant voltage of 2.7 V in an environment of 25° C. and then discharged at a discharge rate of 0.2 C to measure the capacity after reassembly. The measured capacity after reassembly was divided by the initial capacity and multiplied by 100 to obtain a capacity retention rate (%) after reassembly.

### Example 7

A reassembled battery was evaluated in the same manner as in Example 6, except that a vacuum-dried integrated sintered plate degreased by heating at 600° C. for 5 hours was used for reassembling the battery.

### Example 8

A reassembled battery was evaluated in the same manner as in Example 7, except that a degreased integrated sintered plate fired at 800° C. for 10 minutes was used for reassembling the battery.

### Example 9 (Comparison)

A reassembled battery was evaluated in the same manner as in Example 6, except that only the electrolytic solution was replaced without the electrode restoration treatment (cleaning and drying) after disassembling the battery.

Evaluation Results

Table 2 shows the evaluation results for Examples 6 to 9.

TABLE 2

| | | Electrode restoration treatment | | | Evaluation | |
|---|---|---|---|---|---|---|
| | | Cleaning | | | Capacity retention | Capacity retention |
| | Type of | and | | | rate after | rate after |
| | electrode | drying | Degreasing | Firing | storage (%) | reassembly (%) |
| Ex. 6 | Multilayer | Done | None | None | 78 | 87 |
| | ceramic | | | | | |
| | electrode | | | | | |
| Ex. 7 | Multilayer | Done | Done | None | 77 | 88 |
| | ceramic | | | | | |
| | electrode | | | | | |
| Ex. 8 | Multilayer | Done | Done | Done | 75 | 90 |
| | ceramic | | | | | |
| | electrode | | | | | |
| Ex. 9* | Multilayer | None | None | None | 76 | 77 |
| | ceramic | | | | | |
| | electrode | | | | | |

The symbol * indicates a comparative example.

As seen from the results shown in Table 2, the capacity retention rate was significantly restored due to the effect of removing impurities by the electrode restoration treatment in Examples 6 to 8. Meanwhile, the capacity retention rate was not significantly improved in Example 9 that is a comparative example in which only the electrolytic solution was replaced.

What is claimed is:

1. A method for recycling a lithium-ion secondary battery, comprising:
providing a used lithium-ion secondary battery that includes: a battery element including a ceramic positive electrode layer, a ceramic separator, and a ceramic negative electrode layer; an electrolytic solution; and a battery container accommodating the battery element and the electrolytic solution;
taking out the battery element from the lithium-ion secondary battery;
replacing the electrolytic solution in the lithium-ion secondary battery with a fresh electrolytic solution;
subjecting the battery element to an electrode restoration treatment including cleaning and/or heat treatment; and
putting the battery element subjected to the electrode restoration treatment back into the battery container to assemble a lithium-ion secondary battery.

2. The method for recycling a lithium-ion secondary battery according to claim 1, wherein the electrode restoration treatment comprises cleaning the battery element with a polar solvent to remove impurities contained in and/or adhering to the battery element, followed by drying.

3. The method for recycling a lithium-ion secondary battery according to claim 1,
wherein the battery element further comprises a positive electrode current collector and/or a negative electrode current collector,
wherein the positive electrode current collector and/or the negative electrode current collector is detached before and/or during the cleaning, and
wherein the positive electrode current collector and/or the negative electrode current collector is attached to the battery element after the electrode restoration treatment.

4. The method for recycling a lithium-ion secondary battery according to claim 2, wherein the electrode restoration treatment comprises heating, at 300 to 1000° C., the battery element that have cleaned and dried.

5. The method for recycling a lithium-ion secondary battery according to claim 4, wherein the electrode restoration treatment comprises degreasing the battery element at 300 to 600° C. and/or firing the battery element at 650 to 1000° C.

6. The method for recycling a lithium-ion secondary battery according to claim 1, wherein the ceramic positive electrode layer, the ceramic separator, and the ceramic negative electrode layer form one integrated sintered body as a whole.

7. The method for recycling a lithium-ion secondary battery according to claim 1, wherein the ceramic positive electrode layer is composed of a lithium complex oxide sintered body.

8. The method for recycling a lithium-ion secondary battery according to claim 1, wherein the ceramic positive electrode layer is an oriented positive electrode layer containing a plurality of primary grains composed of lithium complex oxide, the plurality of primary grains being oriented at an average orientation angle of over 0° and 30° or less with respect to a layer face of the positive electrode layer.

9. The method for recycling a lithium-ion secondary battery according to claim 7, wherein the lithium complex oxide is lithium cobaltate.

10. The method for recycling a lithium-ion secondary battery according to claim 1, wherein the ceramic negative electrode layer is composed of a titanium-containing sintered body.

11. The method for recycling a lithium-ion secondary battery according to claim 10, wherein the titanium-containing sintered body contains lithium titanate or niobium titanium complex oxide.

12. The method for recycling a lithium-ion secondary battery according to claim 1, wherein the ceramic separator comprises at least one selected from the group consisting of MgO, Al₂O₃, ZrO₂, SiC, Si₃N₄, AlN, and cordierite.

13. The method for recycling a lithium-ion secondary battery according to claim 1, further comprising replacing the battery container with another battery container after the battery element are taken out and before the battery element are put back into the battery container.
